(19) United States
(12) Patent Application Publication
(10) Pub. No.: US 2016/0266591 A1
(43) Pub. Date: Sep. 15, 2016

(54) LOAD-TRACKING FREQUENCY COMPENSATION IN A VOLTAGE REGULATOR

(71) Applicant: QUALCOMM Incorporated, San Diego, CA (US)

(72) Inventors: Jun Hua, San Diego, CA (US); Iulian Mirea, San Diego, CA (US)

(21) Appl. No.: 14/656,398

(22) Filed: Mar. 12, 2015

(51) Int. Cl. G05F 1/445

(52) U.S. Cl. CPC G05F 1/445

(57) ABSTRACT

Disclosed is circuitry having an input stage and an output stage. A first compensation network may be connected to the input and output stages, and configured to split a pole at the input stage and a pole at the output stage. A second compensation network may be connected to the input and output stage. The second compensation network may be configured to suppress peaking of a gain of the circuit at frequencies near the pole at the output stage.

### BACKGROUND

A common challenge in voltage regulator design is to ensure stability over a large variation of output current. In a low dropout regulator (LDO), for example, the LDO should be stable from a no load condition, where no output current is drawn, to a maximum load condition, where the load draws a maximum output current (e.g., 2A). The control loop in a voltage regulator such as an LDO usually has two low-frequency poles, located at the output of an error amplifier and at the regulator output node, respectively. The first pole at the error amplifier output can be relatively fixed. However, the second pole at the output node may change as the load current changes. Under high load conditions (e.g., where the load draws larger amounts of current), the first pole can be the dominant pole and the second pole may be located beyond the unity gain frequency (UG F) of the response curve of the regulator; the voltage regulator is stable. Under light load conditions (e.g., where the load draws smaller amounts of current), however, the second pole may move toward lower frequencies, which could cause the voltage regulator to become unstable.

SUMMARY

In accordance with some embodiments, a circuit may include an input stage and an output stage. The circuit may include a first compensation network connected to the input and output stages. The first compensation network may be configured to split a first pole at the input stage and a second pole at the output stage. The circuit may include a second compensation network connected to the input and output stages. The second compensation network may be configured to suppress peaking of a gain of the circuit at frequencies near the second pole.

In some embodiments, the second compensation network may be configured to establish a pole in the feedback loop to suppress gain peaking of the circuit at frequencies near the second pole. In some embodiments, the second compensation network may be configured to stabilize a feedback loop of the circuit at frequencies near the second pole in response to changes in a loading condition at the output stage.

In some embodiments, the second compensation network may be configured to establish a zero at a frequency that varies with the loading condition at the output of the output stage.

In some embodiments, the input stage may include a cascode stage. The first compensation network may be a capacitor having a connection to the cascode stage.

In some embodiments, the second compensation network may include a resistive element and capacitor. The resistive element may be a MOSFET device.

In accordance with some embodiments, a circuit may include a differential amplifier having a first input, a second input, and an output. The circuit may include a pass device having a control terminal and an output terminal A first compensation network may be connected between the output terminal of the pass device and an internal node of the differential amplifier. A second compensation network may include a variable RC network configured to suppress peaking of a gain of the circuit at frequencies near a pole at the output terminal of the pass device in response to changes in a loading condition at the output terminal of the pass device.

In some embodiments, the first compensation network may be a capacitor configured to provide Miller compensation.

In some embodiments, the differential amplifier may include a cascode output stage, and the first compensation network is connected to a node in the cascode output stage.

In some embodiments, the second compensation network may include a MOSFET device connected in series with a capacitor. The output of the differential amplifier may be electrical communication with the control terminals of both the MOSFET device and the pass device.

In accordance with some embodiments, a circuit may include first means for producing an output signal, second means for producing an error signal, third means for stabilizing operation of the circuit by splitting a first pole at a node in the circuit where the error signal is produced and a second pole at the output node of the circuit, and fourth means for suppressing gain peaking at frequencies above a unity gain frequency of the circuit by establishing a third pole in the feedback loop of the circuit.

In some embodiments, the circuit may further include means for establishing a zero in the feedback loop of the circuit and means for changing a location of the zero in response to a loading condition at the output node of the circuit to compensate for the second pole at the output node of the circuit.

In accordance with some embodiments, a method for a circuit may include producing an output signal at an output node of the circuit, producing an error signal based on a reference signal and the output signal at the output node of the circuit, and regulating the output signal at the output node of the circuit using the error signal. The method may further include stabilizing operation of the circuit by splitting a first pole at a node in the circuit where the error signal is produced and a second pole at the output node of the circuit, and suppressing gain peaking at frequencies above a unity gain frequency of the circuit by establishing a third pole in the feedback loop of the circuit.

In some embodiments, the method may further include establishing a zero in the feedback loop of the circuit and changing a location of the zero in response to a loading condition at the output node of the circuit to compensate for the second pole at the output node of the circuit. In some embodiments, changing the location of the zero includes tracking movement of the second pole as the loading condition changes.

The following detailed description and accompanying drawings provide a better understanding of the nature and advantages of the present disclosure.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. In the accompanying drawings:

FIG. 1 illustrates a block diagram of an amplifier in accordance with the present disclosure.

FIG. 2 illustrates an example of a low dropout (LDO) amplifier in accordance with the present disclosure.

FIG. 3 illustrate additional details of the LDO shown in FIG. 2.

FIGS. 4 and 5 illustrate Bode plots, demonstrating aspects of the present disclosure.

FIG. 6 illustrates operation of an amplifier in accordance with the present disclosure.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

In accordance with the present disclosure, amplifier circuits may be configured with compensation circuitry to provide pole splitting and stable operation at light loads. Further in accordance with the present disclosure, compensation circuitry may be configured to suppress gain peaking that can result due to pole splitting.

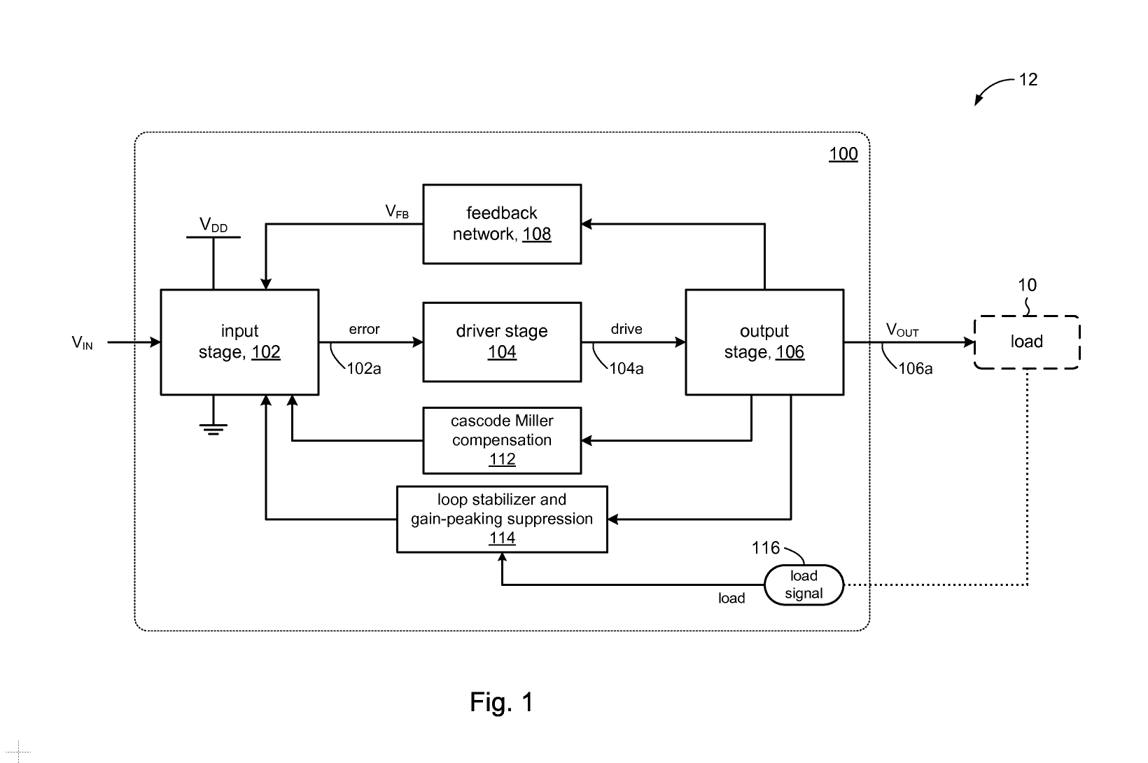

Referring to the high level block diagram in FIG. 1, in some embodiments, an amplifier circuit 100 may comprise an input stage 102 configured to receive an input voltage V_{IN}. The input stage 102 may be configured to generate an error signal at its output 102a. The input stage 102 may connect to a driver stage 104. The driver stage 104 may be configured to generate a drive signal at its output 104a in response to an error signal from the input stage 102. The driver stage 104 may connect to an output stage 106. The drive signal generated in the driver stage 104 may be configured to control the output stage 106 to generate an output signal VouT at an output 106a of the output stage 106. A load 10 may be connected to the amplifier circuit 100 to be driven by V_{OUT}. The output stage 106 may be a means for producing an output signal at output 106a.

The amplifier circuit 100 and load 10 may be components in an electronic device 12. The load 10, for example, may be device electronics in the electronic device 12. The loading (load condition) presented by the load 10 may vary depending on operations going on in the electronic device 12. Merely as an example, suppose the load 10 is a microprocessor, the load condition at the output 106a of output stage 106 may exhibit a high current draw if the microprocessor is heavily used (e.g., processing a video stream). On the other hand, the load condition may be a low current draw if the microprocessor is not running any applications.

The amplifier circuit 100 may include a feedback network 108 that is connected to the input stage 102 and the output stage 106. In some embodiments, for example, the feedback network 108 may connect to outputs 102a, 106a of respective input and output stages 102, 106, or to internal nodes (not shown) of the input and output stages 102, 106, or some combination thereof. The feedback network 108 may be configured to provide some portion of the output signal V_{OUT}, as a feedback signal V_{FB}, back to the input stage 102. The feedback network 108 may be a means for producing an error signal, namely feedback signal V_{FB}.

It is well understood by persons of ordinary skill that the dynamic behavior of amplifier circuit 100 may be represented by its transfer function. The transfer function of amplifier circuit 100 is generally not flat across all frequencies. A gain of amplifier circuit 100 may be greater or less depending on frequency. At some frequencies, the gain may approach infinity or zero. These locations on the transfer function are referred to respectively as “poles” and “zeroes.”

The output signal V_{OUT} may exhibit a time delay relative to the input signal V_{IN} at the frequencies where the poles are located. This delay creates a phase difference between the amplifier input and output. When the phase difference reaches 360°, the output signal V_{OUT} will be in phase with the input signal V_{IN}, and the feedback signal V_{FB} will reinforce the input signal V_{IN} causing the amplifier circuit 100 to oscillate. The operable phase range in which oscillation does not occur is referred to as the “phase margin.”

In accordance with the present disclosure, the amplifier circuit 100 may include a first compensation network 112 connected to the input stage 102 and the output stage 106. In some embodiments, the first compensation network 112 may connect to outputs 102a, 106a of respective input and output stages 102, 106, or to internal nodes of the input and output stages 102, 106, or some combination thereof. In some embodiments, the first compensation network 112 may be configured to provide Miller compensation. The first compensation network 112 may be configured as a means to split a first pole occurring at the output 102a of input stage 102 and a second pole occurring at the output 106a of output stage 106. This aspect of the present disclosure will be discussed in more detail below.

In accordance with the present disclosure, the amplifier circuit 100 may include a second compensation network 114 connected to the input stage 102 and the output stage 106. In some embodiments, the second compensation network 114 may connect to outputs 102a, 106a of respective input and output stages 102, 106, or to internal nodes of the input and output stages 102, 106, or some combination thereof. In some embodiments, the second compensation network 114 may be configured as a means to suppress gain peaking that may occur at certain frequencies. The second compensation network 114 may be further configured to stabilize the feedback loop provided by feedback network 108.

In accordance with the present disclosure, the amplifier circuit 100 may include a source for a load signal 116 indicative of the load condition at the output 106a of output stage 106. In accordance with the present disclosure, the second compensation network 114 may be configured to vary its electrical characteristic in response to the load signal 116. Persons of ordinary skill will appreciate that the load signal 116 indicating a load condition at the output 106a may be generated or otherwise obtained in any of several ways. In some embodiments, for example, circuitry (not shown) configured to sense the output voltage at output 106a may provide a signal indicative of the loading at the output 106a. The current flow at output 106a may be sensed. In other embodiments, signals generated within the amplifier circuitry 100 may be used as an indication of the loading condition.

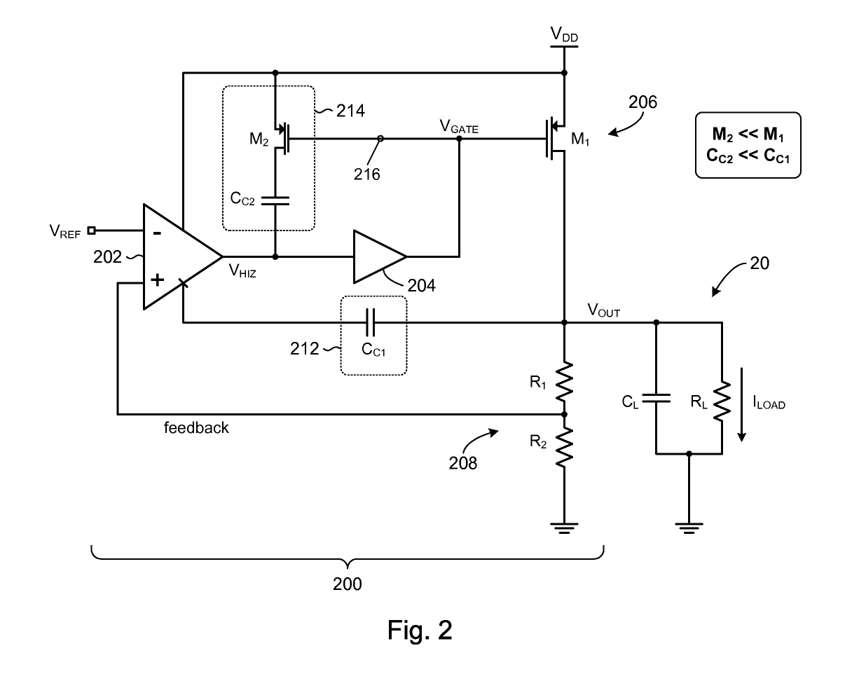

In some embodiments in accordance with the present disclosure, the amplifier circuit 100 shown in FIG. 1 may be configured as a voltage regulator. FIG. 2, for example, shows a low dropout (LDO) voltage regulator 200 configuration in accordance with some embodiments of the present disclosure. The LDO 200 may be configured to drive a load 20 (R_{L}/C_{L}) connected to output V_{OUT}.

The LDO 200 may include an input stage comprising a differential amplifier 202. An input voltage V_{REF} may be connected to an inverting input of differential amplifier 202. A high impedance output V_{HIZ} of differential amplifier 202 may be connected to a driver stage comprising a buffer 204.

The output stage 206 may be means for producing an output signal, and in some embodiments may be a pass device M₁. In some embodiments, for example, pass device M₁ may be a power MOSFET. Due to the large size that typically characterizes power devices, the gate capacitance of M₁ may be significant. Accordingly, the buffer 204 may be configured to provide a drive signal V_{GATE} sufficiently large to drive the gate of M₁. A feedback network may be a means for producing an error signal, and in some embodiments may comprise a resistor divider 208 of R₁, R₂ that provides a feedback path to the non-inverting input of the differential amplifier 202.

In accordance with the present disclosure, the first compensation network 212 may comprise a capacitor C_{C1} configured to provide Miller compensation. In some embodiments, the C_{C1} capacitor may be connected between the output V_{OUT} and an internal node in the differential amplifier 202.

The second compensation network 214 may comprise a transistor device M₂ connected in series with capacitor C_{C2}. In some embodiments, the second compensation network 214 may be connected between supply V_{DD} and the output V_{HIZ} of differential amplifier 202. In some embodiments, the drive signal V_{GATE} provided by buffer 204 may serve as a load signal 216 that is indicative of the loading condition (e.g., magnitude of output current I_{LOAD}) created by the load 20 at output V_{OUT}.

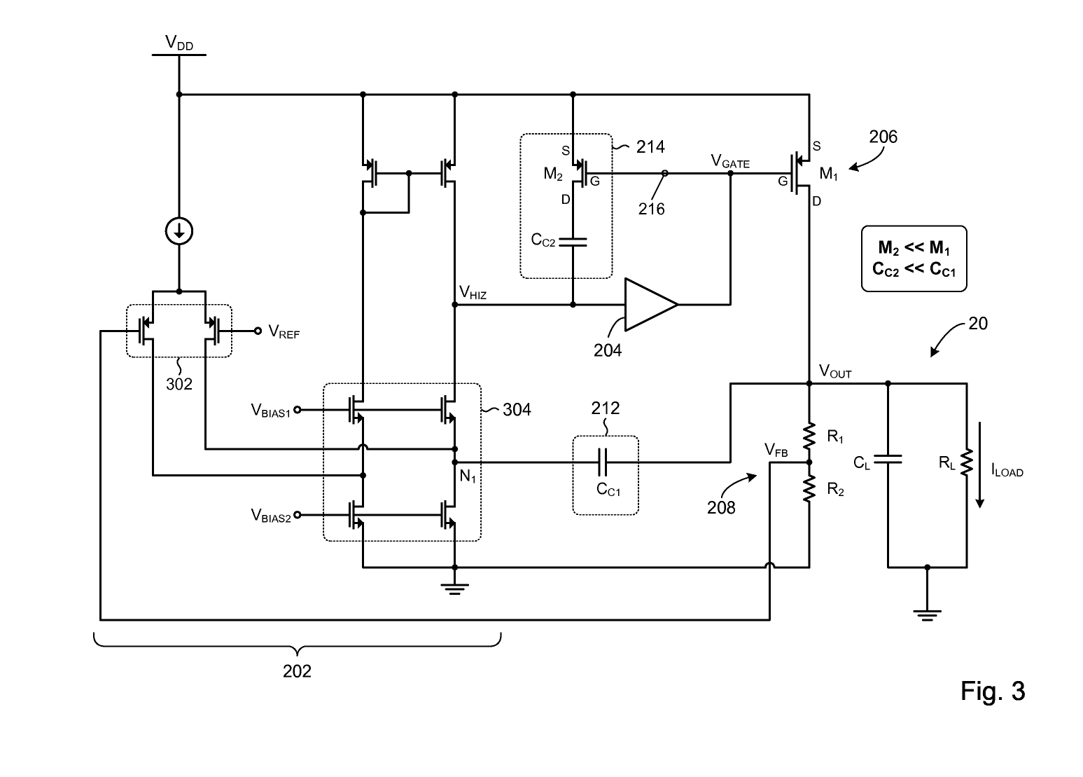

In accordance with the present disclosure, the first compensation circuit 212 may be connected to an internal node in the differential amplifier 202. Referring to FIG. 3, for example, the differential amplifier 202 in accordance with some embodiments may comprise input transistors 302 connected to a folded cascode output stage 304. In some embodiments, the capacitor C_{C1} may connect to a node N₁ in the folded cascode output stage 304. This configuration of the capacitor C_{C1} may improve the power supply rejection ratio (PSRR).

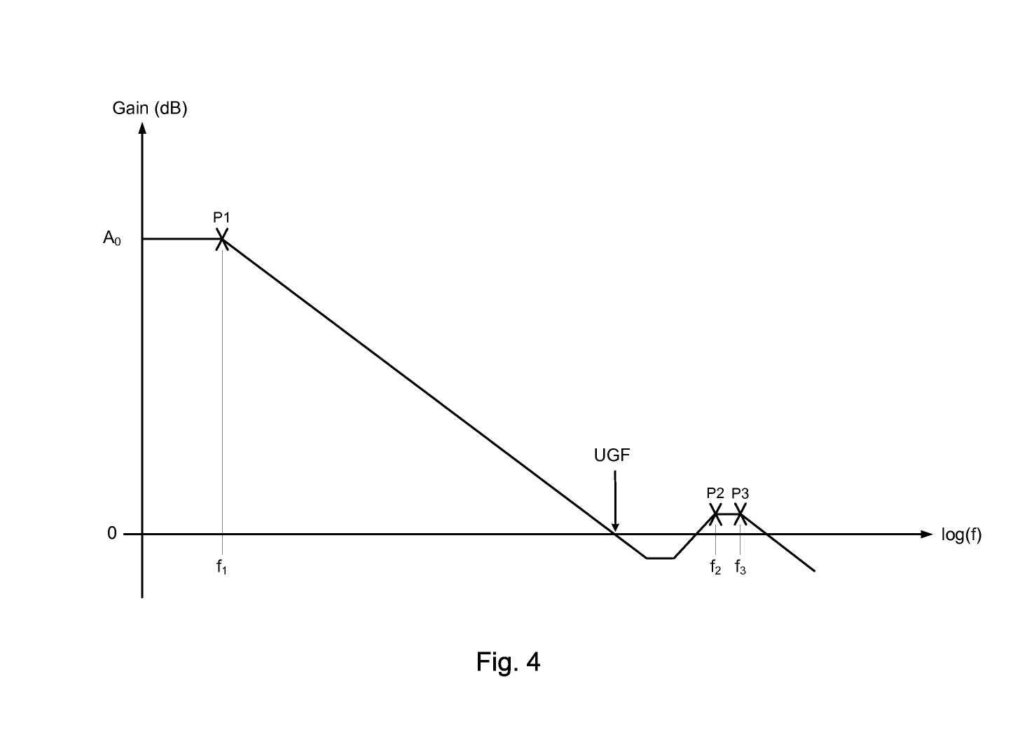

In operation, the C_{C1} capacitor may serve as a Miller compensation capacitor. The C_{C1} capacitor may set the dominant pole at V_{HIZ} while at the same time making the pole at V_{OUT} less so. In other words, as the pole at V_{HIZ} moves down in frequency, the pole at V_{OUT} moves up in frequency. This spreading of the poles is referred to as “pole splitting.” Pole splitting can force the resulting transfer function to appear first-order over a large frequency range, and can serve as means for stabilizing operation of the LDO 200 over a large frequency range. However, at high frequency, the transfer function can exhibit gain peaking. This is illustrated in FIG. 4, for example. The Bode plot in FIG. 4 shows a dominant pole P₁ at f₁ at the low end of the frequency range. A non-dominant pole P₂ is pushed to a frequency f₂ higher than unity gain frequency (UGF), for example by the C_{C1} capacitor. FIG. 4 shows that gain-peaking may occur at poles P₂ and P₃ at f₃. The particular location of gain-peaking frequency depends on circuit parameters and parasitics, but usually it is a bit higher than UGF. Gain-peaking may cause instability because the gain is >0 dB while phase shift is >180° at those frequencies.

In accordance with the present disclosure, the C_{C2} capacitor may be much smaller than the C_{C1} capacitor. In some embodiments, for example, the size of C_{C2} may be 10% the size of C_{C1}. In other embodiments, the size of C_{C2} may be different but nonetheless smaller than the size of C_{C1}. A suitably sized C_{C2} capacitor can therefore provide a high-frequency pole in the feedback loop to suppress gain peaking associated with cascode Miller compensation, and may serve as a means for suppressing gain peaking. This aspect of the present disclosure will be described in more detail below.

In accordance with the present disclosure, the C_{C2} capacitor can operate with M₂ as a means for establishing a load-tracking zero to boost phase margin. As noted above, in some embodiments, the V_{GATE} output of buffer 204 may serve as an indication of the loading condition at V_{OUT} and thus may be used as a load tracking signal. In some embodiments, M₂ may be a FET much smaller than M₁. The drive signal V_{GATE} from buffer 204 may drive the gates of M₁ and M₂. Accordingly, M₂ shares the same V_{GS} with M₁. Since the V_{DS} of M₂ is 0V, M₂ operates in the deep triode region as a resistor. When the loading condition at V_{OUT} increases (high load), the drive signal V_{GATE} will increase to increase the load current through M₁. Merely as an example, suppose the load 20 is a transmitter in a mobile communication device. When the transmitter is transmitting a signal, the transmitter will consume power and thus draw more current (e.g., through M₁) than when the transmitter is quiescent. As the drive signal V_{GATE} increases to increase current across M₁, the V_{GS} of M₁ and M₂ will increase. The ON resistance of M₂ will therefore decrease. This can result in a change in the complex impedance of the RC circuit defined by M₂ and C_{C2} thus locating the zero formed by C_{C2} and M₂ at a high frequency (e.g.,

$${f}_{Z} = \frac{1}{2 π {R}_{M 2} {C}_{C 2}} \text{)} .$$

The V_{GS} provided to M₁ and M₂ may therefore serve as a means for changing the location of the zero. However, since the output pole at V_{OUT} also moves to a high frequency under high load conditions, the high frequency zero provided by C_{C2} and M₂ under high load conditions does not add more to the stability of the control loop.

When the load condition at V_{OUT} decreases (light load), the load current is low. Using the transmitter example above as load 20, when the transmitter is in idle mode (not transmitting), the transmitter may consume less power than when the transmitter is transmitting and thus may represent an example of a light load condition. Under light load conditions, the drive signal V_{GATE} is low, and so the V_{GS} of M₁ and M₂ is low. Accordingly, the ON resistance of M₂ becomes high and the zero formed by C_{C2} and M₂ will move to a low frequency. Since the output pole at V_{OUT} also moves to a low frequency under light load conditions, the location of the zero set by C_{C2} and M₂ effectively tracks the movement of the pole at output V_{OUT}, and thus can cancel the negative effects of a low frequency pole at output V_{OUT}.

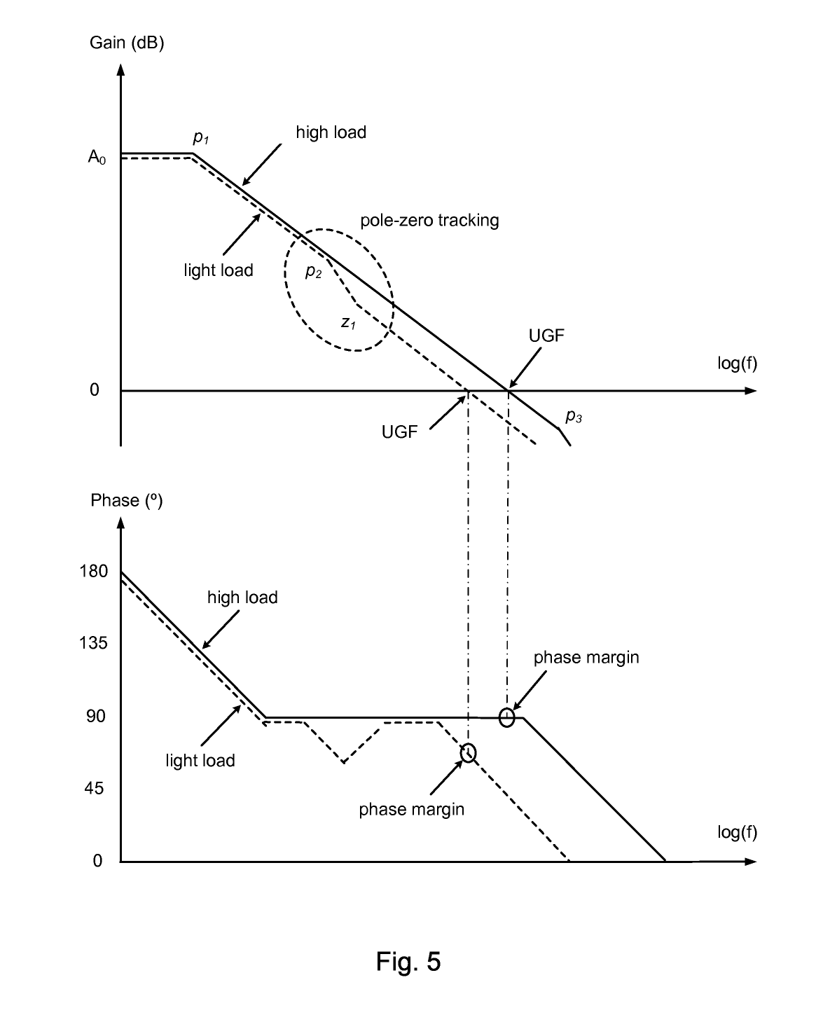

Referring to FIG. 5, a Bode plot shows a magnitude response and a phase response of a circuit (e.g., FIG. 3) in accordance with the present disclosure. Response curves for a high load condition and for a light load condition are illustrated. A pole P₁ at the output V_{HIZ} may be established at the low end of the frequency range, for example, by the C_{C1} capacitor. A pole P₂ represents the pole at the output V_{OUT}, and will vary depending on the loading condition at V_{OUT}. The pole P₂ is not shown on the high load response curve; it will be understood to be at high frequency beyond UGF, and thus does not present a risk for destabilizing the circuit.

The pole P₂ is represented on the light load response curve. Under light loads, the location of pole P₂ is in the lower portion of the frequency range of the transfer function, and thus represents a high risk of causing the circuit become unstable. A load-tracking zero Z₁ may be created by M₂ and C_{C2}, and as explained above, can track the movement of pole P₂ as the load condition varies. The presence of the zero Z₁ serves to cancel the destabilizing effect of pole P₂. Since the zero Z₁ can track with the load condition at the output as the pole P₂ can, the tendency of pole P₂ to destabilize the circuit at low frequencies under light load condition can be canceled by the zero Z₁.

A pole P₃ may be established by the C_{C2} capacitor. Recall from FIG. 4, that gain-peaking can occur at high frequency due to Miller compensation using C_{C1}. The gain-peaking effect can be suppressed for by properly locating the pole P₃ using C_{C2}. The pole P₃ will force the gain to fall with a slope of −20 db/decade, thus suppressing gain-peaking.

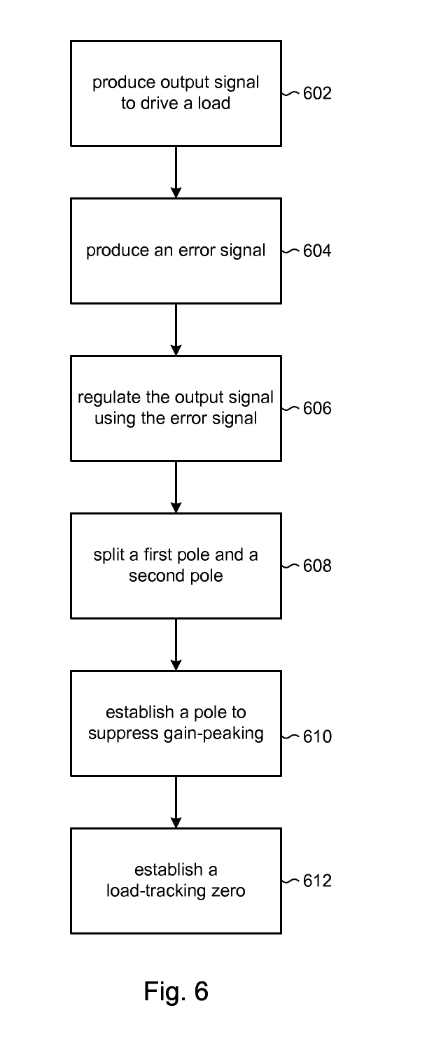

FIG. 6 illustrates operation of circuitry (e.g., FIG. 3) in accordance with the present disclosure. At 602, the circuitry may produce an output signal to drive a load. At 604, the circuitry may produce an error signal. In some embodiments, for example, the circuitry may include a voltage divider to produce a feedback signal, which may be compared to a reference signal. The error signal may represent an outcome of the comparison. At 606, the output signal may be regulated by the error signal. In some embodiments, for example, the error signal may be used to drive an output stage and thus vary the output signal.

At 608, the circuitry may include splitting a dominant pole and a non-dominant pole to ensure stable operation over a large variation of output current. In some embodiments, for example, the dominant pole may be at the output of an error amplifier that produces the error signal. The non-dominant pole may be at the output of the output signal.

At 610, the circuitry may include establishing a high frequency pole at the output of the output signal to suppress gain-peaking that can result from the pole splitting.

At 612, the circuitry may include establishing a load-tracking zero at the output of the output signal. In some embodiments, this may include driving an RC circuit with error signal where the RC circuit includes a transistor having a gate that is driven by the error signal. In some embodiments, the capacitor in the RC circuit may serve to establish the high frequency pole to suppress gain-peaking.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

We claim the following:

1. A circuit comprising:
an input stage having an input configured to connect to an input voltage;
an output stage having an output, the output stage configured to produce an output voltage on the output;
a first compensation network connected to the input stage and the output stage and configured to split a first pole at an output of the input stage and a second pole at the output of the output stage; and
a second compensation network connected to the input stage and the output stage, the second compensation network configured to suppress peaking of a gain of the circuit at frequencies near the second pole.

2. The circuit of claim 1, wherein the second compensation network is configured to establish a pole at the output of the output stage to suppress gain peaking of the circuit at frequencies near the second pole.

3. The circuit of claim 2, further comprising a feedback loop connected to the input stage and to the output stage, wherein the second compensation network is configured to establish the pole in the feedback loop.

4. The circuit of claim 1, further comprising a feedback loop connected to the input stage and to the output stage, the second compensation network further configured to stabilize the feedback loop at frequencies near the second pole in response to changes in a loading condition at the output of the output stage.

5. The circuit of claim 1, wherein the second compensation network is configured to establish a zero at a frequency that varies with the loading condition at the output of the output stage.

6. The circuit of claim 5, further comprising a signal source configured to produce a signal indicative of a loading condition at the output of the output stage.

7. The circuit of claim 5, wherein a signal at the output of the input stage is representative of the loading condition at the output of the output stage.

8. The circuit of claim 1, wherein the input stage includes a cascode stage and the first compensation network comprises a capacitor connected to the cascode stage.

9. The circuit of claim 8, wherein the first compensation network does not include a resistive element.

10. The circuit of claim 1, wherein the second compensation network comprises a resistive element and capacitor.

11. The circuit of claim 10, wherein the resistive element is a MOSFET device.

12. The circuit of claim 1, wherein the input voltage is a reference voltage and the circuit is configured to regulate an output voltage on the output of the output stage based on the reference voltage.

13. A circuit comprising:
a differential amplifier having a first input, a second input, and an output, the first input configured to connect to an external voltage source;
a pass device having a control terminal and an output terminal, the control terminal in electrical communication with the output of the differential amplifier;
a feedback network connected between the output terminal of the pass device and the second input of the differential amplifier;
a first compensation network connected between the output terminal of the pass device and an internal node of the differential amplifier; and
a second compensation network comprising a variable RC network configured to suppress peaking of a gain of the circuit at frequencies near a pole at the output terminal of the pass device in response to changes in a loading condition at the output terminal of the pass device.

14. The circuit of claim 13, wherein the first compensation network comprises a capacitor configured to provide Miller compensation.

15. The circuit of claim 13, wherein the differential amplifier comprises a cascode stage, wherein the first compensation network is connected to a node in the cascode stage.

16. The circuit of claim 15, wherein the first compensation network comprises a capacitor connected between the output terminal of the pass device and the node in the cascode stage of the differential amplifier.

17. The circuit of claim 13, wherein the feedback network comprises a resistor divider network connected to the output terminal of the pass device, wherein the first compensation network is connected to a node in the resistor divider network.

18. The circuit of claim 13, wherein the variable RC network of the second compensation network comprises a MOSFET device connected in series with a capacitor, the output of the differential amplifier in electrical communication with the control terminals of both the MOSFET device and the pass device.

19. The circuit of claim 18, further comprising a buffer circuit having an input connected to the output of the differential amplifier and the capacitor of the variable RC network, the buffer circuit further having an output connected to the control terminals of both the MOSFET device and the pass device.

20. A circuit comprising:
first means for producing an output signal at an output node of the circuit;
second means for producing an error signal based on a reference signal and the output signal at the output node of the circuit;
third means for stabilizing operation of the circuit by splitting a first pole at a node in the circuit where the error signal is produced and a second pole at the output node of the circuit; and
fourth means for suppressing gain peaking at frequencies above a unity gain frequency of the circuit by establishing a third pole at the output node of the circuit.

21. The circuit of claim 20, further comprising:
means for establishing a zero at the output node of the circuit; and
means for changing a location of the zero in response to a loading condition at the output node of the circuit to compensate for the second pole the output node of the circuit.

22. The circuit of claim 21, wherein a location of the second pole changes as the loading condition at the output node changes, wherein changing the location of the zero includes tracking movement of the second pole.

23. The circuit of claim 21, wherein means for changing the location of the zero includes setting a complex impedance of an RC network in the circuit using a signal representative of the loading condition at the output node of the circuit.

24. The circuit of claim 20, further comprising means for producing a feedback signal using a resistor divider network connected to the output node of the circuit and comparing the feedback signal with the reference signal to produce the error signal.

25. A method in a circuit comprising:
producing an output signal at an output node of the circuit;
producing an error signal based on a reference signal and the output signal at the output node of the circuit;
regulating the output signal at the output node of the circuit using the error signal;
stabilizing operation of the circuit by splitting a first pole at a node in the circuit where the error signal is produced and a second pole at the output node of the circuit; and
suppressing gain peaking at frequencies above a unity gain frequency of the circuit by establishing a third pole at the output node of the circuit.

26. The method of claim 25, further comprising:
establishing a zero at the output node of the circuit; and
changing a location of the zero in response to a loading condition at the output node of the circuit to compensate for the second pole the output node of the circuit.

27. The method of claim 26, wherein a location of the second pole changes as the loading condition at the output node changes, wherein changing the location of the zero includes tracking movement of the second pole.

28. The method of claim 26, wherein changing the location of the zero includes setting a complex impedance of an RC network in the circuit using a signal representative of the loading condition at the output node of the circuit.

29. The method of claim 25, further comprising producing a feedback signal using a resistor divider network connected to the output node of the circuit and comparing the feedback signal with the reference signal to produce the error signal.
